(19) United States
(12) Patent Application Publication
(10) Pub. No.: US 2015/0019356 A1
(43) Pub. Date: Jan. 15, 2015

(54) SYSTEM AND METHOD FOR OVERLAYING BUSINESS DATA ON TOP OF TOUCH SCREEN TERMINALS USED IN POINT OF SALE SYSTEMS

(71) Applicant: CONNECTED MERCHANT, INC., Austin, TX (US)

(72) Inventors: Richard M. Bagdonas, Austin, TX (US); Bryan R. Menell, Austin, TX (US)

(73) Assignee: CONNECTED MERCHANT, INC., Austin, TX (US)

(21) Appl. No.: 14/221,175

(22) Filed: Mar. 20, 2014

Related U.S. Application Data
(60) Provisional application No. 61/803,650, filed on Mar. 20, 2013.

(51) Int. Cl. G06Q 20/20; G06F 3/0484; G06F 3/0488; G06Q 30/00

(52) U.S. Cl. CPC G06Q 20/202; G06Q 30/016; G06F 3/04842; G06F 3/0488; G06F 3/04845
USPC 705/21; 705/16

(57) ABSTRACT

A system is provided which includes a point of sale (POS) terminal (101) equipped with a touch screen display (103) and having a first instance of POS software thereon that renders a first window (105) on the display which is populated with a plurality of interactable objects. A second instance of POS software installed on the POS terminal generates a user selectable object (107a-d) on the display, wherein selection of the user selectable object generates a floating window (109) which occupies a first region of the display and which floats over any objects rendered in the first region by the first POS software.

### CROSS-REFERENCE TO RELATED APPLICATION

This application claims the benefit of U.S. Provisional Application No. 61/803,650, filed Mar. 20, 2013, having the same inventors and title, and which is incorporated herein by reference in its entirety.

### FIELD OF THE DISCLOSURE

The present disclosure relates in general to point of sale (POS) systems, and more particularly to methods, and software for implementing such methods, which overlay business data on touch screen terminals.

### BACKGROUND OF THE DISCLOSURE

Various Point of Sale (POS) systems have been developed in the art. Such systems are widely used in commerce, and frequently include a touch screen terminal that has been equipped with software customized to the business of the end user.

The hospitality industry is a growing area of use for POS systems. For example, restaurants have been making increasing use of POS systems, due to their ability to efficiently handle a wide range of tasks. Thus, for example, a restaurant POS system may be equipped with software that allows employees to enter or modify orders, maintain a running sales total on a customer-by-customer basis, handle payments and credit card transactions, manage reservations, track the availability of menu items, and handle various other matters for the associated business.

Increasingly, POS systems are also being utilized to further enhance customer experience in the hospitality industry and to provide new ways of interacting with patrons. By way of example, the MAHANA™ consumer mobile application communicates in real time with restaurant POS systems to alert restaurant staff members when a patron arrives, and to inform them of the patron's preferences and food allergies. This application also lets restaurants know who their best customers are, so they can provide unique benefits and experiences to them. A further example is the mobile application described in commonly assigned U.S. 2013/0254107 (McClure et al.), which discloses systems and methods for making secure payments in face-to-face transactions.

### BRIEF DESCRIPTION OF THE DRAWINGS

FIGS. 1-4 are illustrations of a first particular, non-limiting embodiment of a system in accordance with the teachings herein for creating an overlay on a POS terminal.

FIG. 5 is an illustration of a mobile network that may be utilized to provide communications between a mobile communications device and a restaurant beacon for the purpose of providing business information to display in an overlay.

FIG. 6 is an illustration of a second particular, non-limiting embodiment of a system for using overlays in a restaurant POS to enable additional customer services.

### SUMMARY OF THE DISCLOSURE

In one aspect, a system is provided which comprises a point of sale (POS) terminal equipped with a touch screen display and having a first instance of POS software thereon that renders a first window on the display which is populated with a plurality of interactable objects. A second instance of POS software installed on the POS terminal generates a user selectable object on the display, wherein selection of the user selectable object generates a floating window which occupies a first region of the display and which floats over any objects rendered in the first region by the first POS software.

In another aspect, in combination with a point of sale (POS) terminal equipped with a touch screen display, a tangible, non-transient, computer readable medium is provided having suitable programming instructions recorded therein which, when executed by one or more computer processors, performs the method comprising (a) rendering a first window on the display which is populated with a plurality of interactable objects; and (b) generating a user selectable object on the display, wherein selection of the user selectable object generates an overlay in the form of a floating window that occupies a first region of the display and which floats over any objects rendered in the first region.

### DETAILED DESCRIPTION

Due to the diverse functionalities offered by POS systems, and the need to provide an intuitive interface in which these various functionalities may be readily accessed, the real estate available on a typical graphical user interface (GUI) provided by POS software is frequently limited. For example, the GUI on a restaurant POS is often densely populated with screen text and buttons that keep a running total of a customer's order, as well as buttons and commands for adding to and manipulating the customer's order.

As a result of the foregoing, the room available to display other business information and to take actions based upon that information is limited. Hence, when it is necessary for the system to interact with other software such as the MAHANA™ consumer mobile application or the face-to-face payment application disclosed in U.S. 2013/0254107 (McClure et al.), it is often necessary to open a new window on the POS display. This is undesirable in that the ability of the user to interact with the features on the main window must then be put on hold while a new window is opened and interacted with. While this issue may be overcome by providing a dedicated POS terminal to run such software, this is generally considered undesirable to the owners of restaurant and other hospitality establishments. In particular, many such establishments already have multiple POS terminals installed, and hence have little enthusiasm for installing additional POS terminals. Therefore, the owners of these establishments are frequently required to make the undesirable choice between installing additional POS hardware, reducing the efficiency of the main POS software by toggling between multiple software applications or windows, or foregoing the additional functionality and features that additional software applications can provide.

It has now been found that the foregoing needs in the art may be met by the systems and methodologies disclosed herein. In a preferred embodiment, these systems and methodologies create an overlay or floating window which floats over the main screen in a POS, and which provides a platform for the display of additional business data. Advantageously, the overlay is movable about the screen, and the user may interact with features on the main window of the POS which are not covered by the overlay without causing the overlay to close or to lose focus. Moreover, the software which creates the overlay operates independently of other applications running on the POS system, and hence does not require any customization to the POS system software or hardware.

Preferably, the overlay is transformable between a first state in which it is minimized (preferably to an icon which may be located in an open portion of the screen, such as a corner), and a second state in which the overlay is expanded so that its contents may be readily discerned. Preferably, when the overlay is in the first state, it is equipped with a notification feature to indicate when new business information is available in the overlay. For example, if the overlay is displayed as an icon in the first state, the icon may blink or change color when new business information is available.

By way of example, but not limitation, the overlay may be utilized to interact with various other software applications or systems, while still allowing the user to view and interact with a significant portion of the main POS window (and, in the event that the overlay is obscuring a portion of the main POS window that the user wishes to view, the overlay may be simply moved to another part of the screen). For example, the overlay may be utilized to interact with the MAHANA™ consumer mobile application. This application is described, for example, at http://vimeo.com/813573797, http://www.getmahana.com/ and http://angel.co/mahana, all of which are incorporated herein by reference in their entirety. The overlay may also be utilized to interact with the face-to-face payment application disclosed in U.S. 2013/0254107 (McClure et al.), which is also incorporated herein by reference in its entirety.

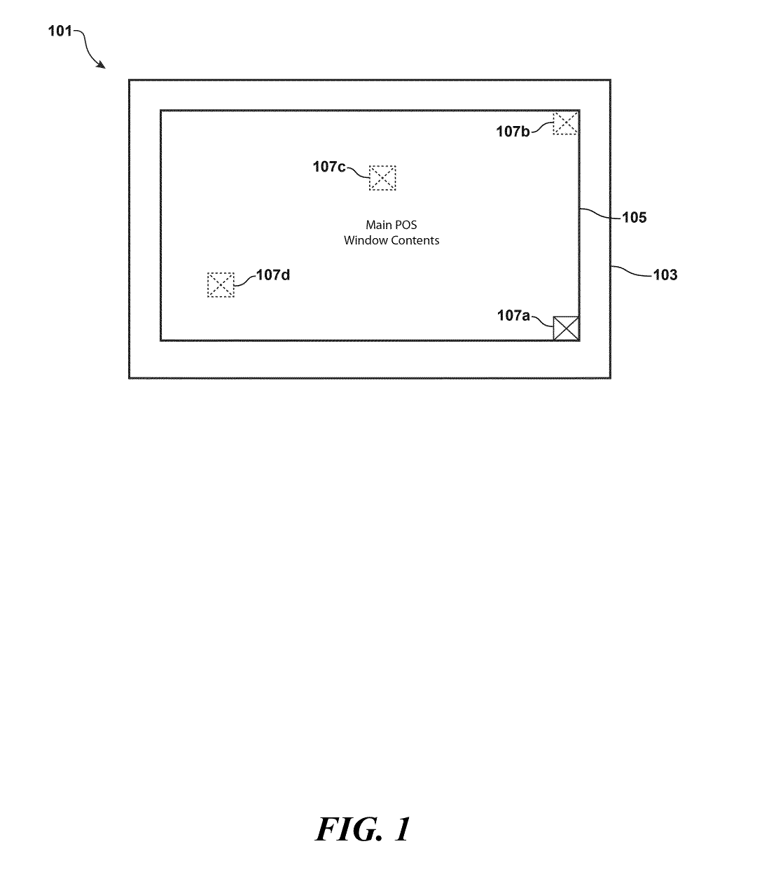

FIG. 1 depicts a first particular, non-limiting embodiment of a POS terminal equipped with a system in accordance with the teachings herein. As seen therein, the POS terminal 101 depicted includes a touch screen 103 having a main window 105 rendered thereon within which may be found the typical contents of a POS terminal. Thus, for example, the main window 105 may comprise various buttons, text, links, images, or other features which allow the user to interact with the POS terminal for a particular purpose such as, for example, managing a restaurant.

A button 107 is disposed in a corner of the main window 105. The button 107 is repositionable to any position on the main window 105 or screen 103. The button 107 may have any desired degree of transparency, and hence may have a low level of transparency (that is, it may be essentially completely opaque so as to completely occlude any object beneath it) or a high level of transparency (that is, underlying objects may be readably discernible through it). In variations of this embodiment, the button 107 may be an image, text, logo, or virtually any other rendered element.

The button 107 is repositionable to any desired position on the on the main window 105. The button 107 may be manually repositioned by the user (e.g., by specifying a location or by dragging the button to a desired location), or may be dynamically repositioned by the software (e.g., by analyzing features in the underlying window). As an example of the later, the software may be configured to reposition the button 107 as necessary so that it avoids overlapping objects on the underlying screen, or by positioning the button 107 as necessary so that any such overlap is minimal.

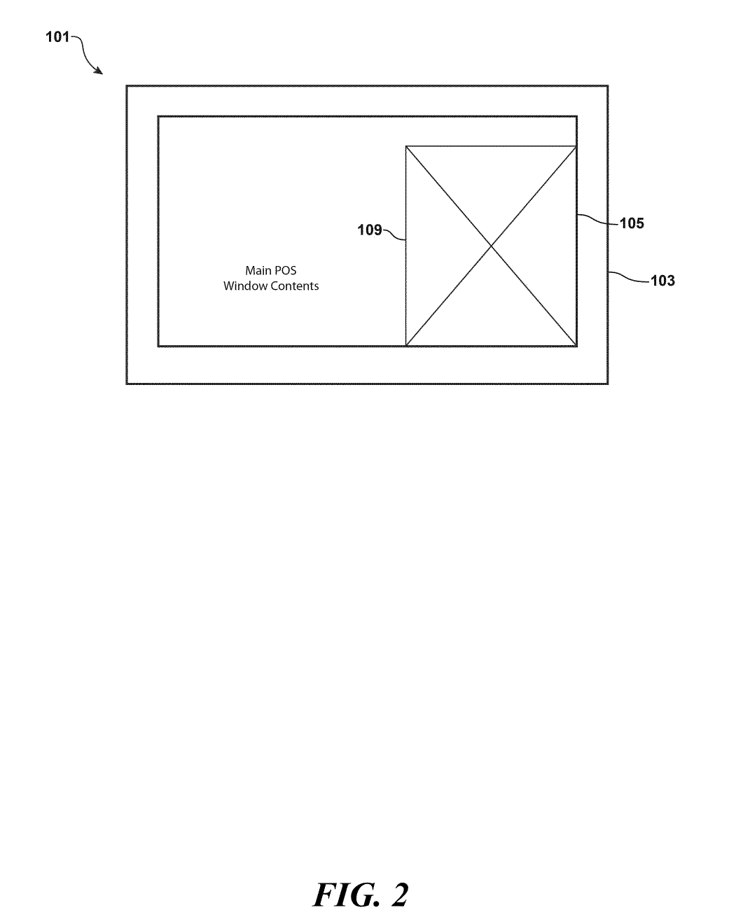

As seen in FIG. 2, upon selection or by other suitable means, the button 107 launches or expands into an overlay 109 or floating window within which content may be displayed. The overlay may be any desired size, and may even be larger than the apparent size of the physical screen. The overlay and/or any content contained therein may be displayed immediately upon selection of the button 107, or an animation may be provided to transition from the button 107 to the final appearance of the overlay 109.

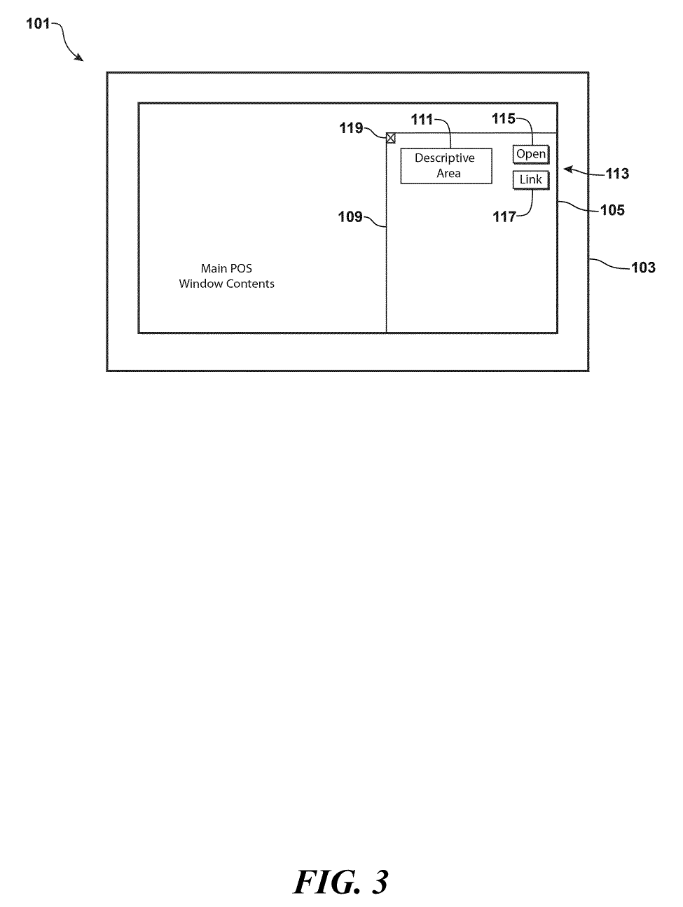

FIG. 3 illustrates how business information may appear in the overlay 109. In the particular embodiment depicted, the overlay has a descriptive area 111 and an action area 113. The descriptive area 111 may contain images, text, sounds or animations, while the action area contains buttons 115, 117 or other objects through which the information in the descriptive area may be acted upon.

In the particular embodiment depicted, the overlay 109 contains two action buttons 115, 117 that take action on the POS system. The open button 115 creates or opens a new ticket or order on the POS system with the business information in the descriptive area 111 and other related data being linked to that ticket. For example, in a particular, non-limiting application, the descriptive area 111 may contain a customer's name, and the open button 115 may open a new ticket which contains the customer's name in the ticket information. The link button 117 operates to link business information contained in the descriptive area to an existing ticket or order in the POS system. Of course, it will be appreciated that the labels on these buttons are not limiting. Hence, embodiments of the systems and methodologies disclosed herein are possible in which the buttons have other labels or are replaced by other objects, but retain the same functionality. In addition, a button 119 is provided to close the overlay, so that only the original button 107 is displayed.

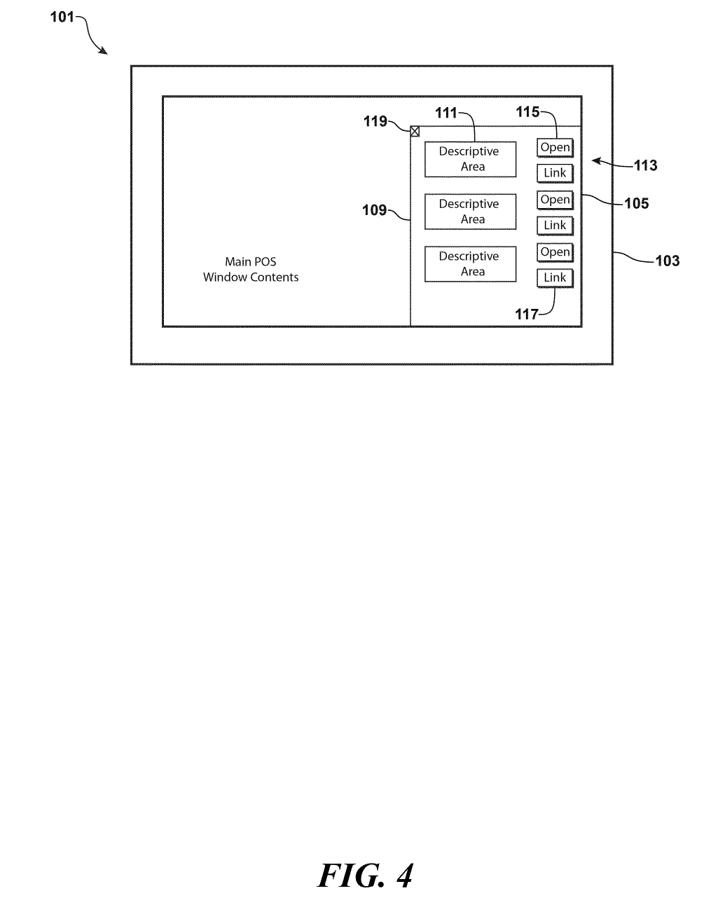

As seen in FIG. 4, additional business information may be added to the overlay 109 at any time. Thus, in the particular case depicted, the overlay 109 includes three descriptive areas 111, each having a unique piece of business information therein. Each piece of business information in one of these descriptive areas may be acted upon independently of the other descriptive areas.

It will be appreciated that, in some embodiments, the overlay 109 may be equipped with scroll bars or other control features which allow the overlay 109 to be larger than the immediately viewable portion and which provide a means for the non- visible portion of the overlay 109 to be viewed. It will also be appreciated that various algorithms may be utilized to govern display of items in the overlay 109. For example, these items may be listed in chronological order, with the most recent items listed at the top of the overlay 109.

While floating windows are used, for example, in the Microsoft WINDOWS® operating system, the software that runs on POS systems typically does not allow windows to float on top of the main application screen or the objects contained therein. Hence, in order to achieve the overlay described in FIGS. 1-4, special precautions must be taken.

In particular, many POS terminals run a WINDOWS® operating system (OS). In the Windows OS, there are specific events that software can track or “listen” for. One such event arises when a piece of software other than the software presenting the overlay is being interacted with by the user. This may happen, for example, if the user touches an object on the main window of the POS that is not covered by the overlay.

Normally, the foregoing type of event would cause the POS software to come to the foreground and would cause the overlay to go to the background (that is, this type of event would cause the overlay to lose focus). However, in a preferred embodiment, the software disclosed herein is adapted to recognize this type of event and to force the overlay to remain on top in spite of the occurrence of such an event. Advantageously, this feature allows the user to interact with the software behind then overlay, without causing the overlay to lose focus.

Moreover, the software is preferably adapted to allow screen touches that do not interact with the overlay to pass through to the underlying POS software. This feature prevents the overlay from adversely affecting the speed of the POS system, since not every touch or keystroke is required to pass through the software that creates the overlay in order to reach the software that operates the main window of the POS.

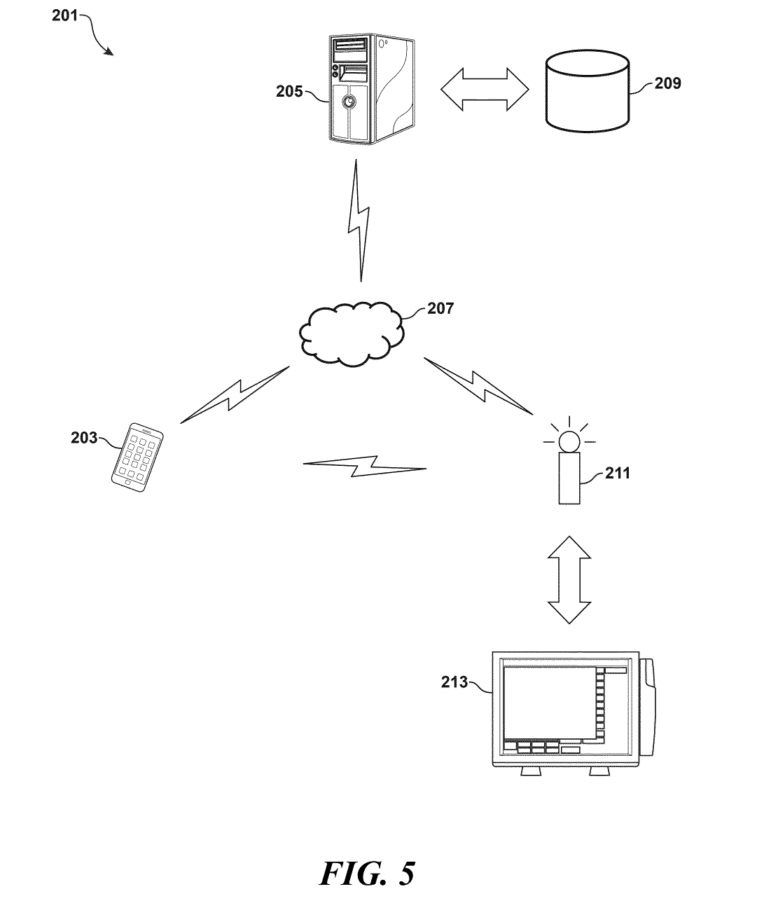

In some embodiments of the systems and methodologies disclosed herein, a mobile client on a mobile communications device may interact with the overlay on a POS to display relevant business information on the overlay (e.g., in the descriptive area of FIGS. 3-4). FIG. 5 illustrates an example of a communications network over which such an interaction might occur.

As seen therein, the network 201 depicted comprises a mobile communications device 203 which is in communication with a server 205 over a network 207 (in the embodiment depicted, the network 207 is a cloud-based network). The server 205 has a database 209 associated with it. A beacon 211 is provided at an establishment which is in communication with a POS terminal 213 and which detects the mobile communications device 203 as the mobile communications device 203 approaches the establishment. For example, the beacon 211 may be part of a geofence erected around the establishment.

A mobile client on the mobile communications device 203 receives the signal from the beacon 211, and communicates this fact to the server 205. The server 205 makes an entry in the database 209. On the other side of the network 201, the software that creates the overlay pulls down the relevant information from the server 205 to present to the overlay on the POS terminal 213.

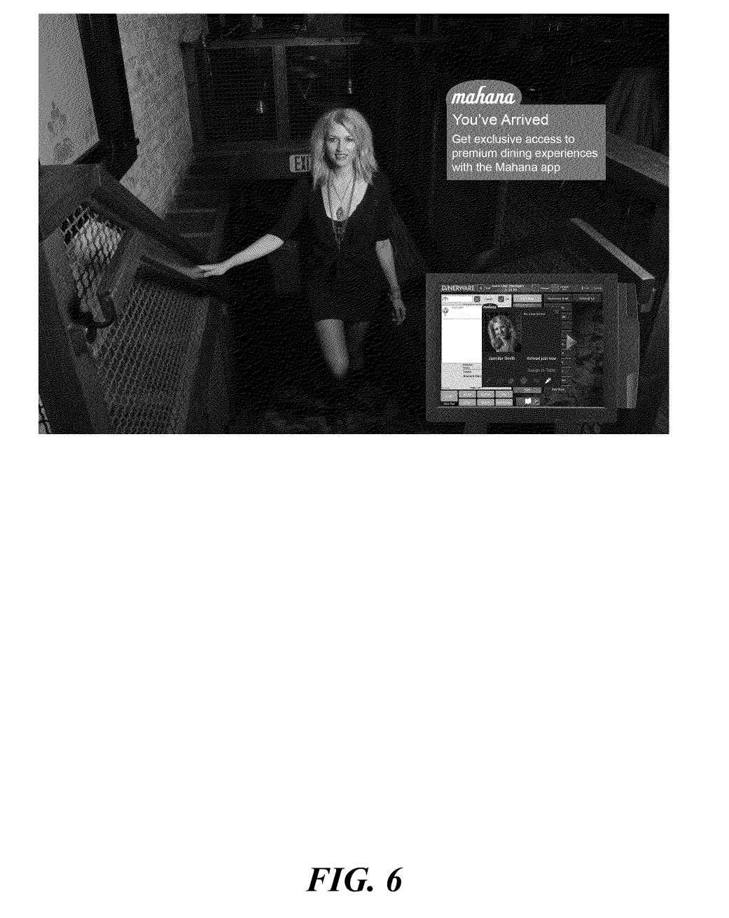

FIG. 6 illustrates an example of a system in which a mobile client interacts with a POS terminal via a network of the type depicted in FIG. 5 to push business information to the overlay on the POS terminal. In the system 301 illustrated therein, a customer 303 enters a restaurant establishment. A mobile application (in this case, the Mahana mobile application) installed on the customer's mobile communications device (not shown) communicates with a POS terminal 305 at the establishment in the manner described with respect to FIG. 5. As a result, information about the customer 303 is pushed to an overlay 307 on the POS 305.

As a result of the information pushed to the overlay 307, the maitre de or other restaurant staff is provided with a picture of the customer, the customer's name, when the customer arrived, and various other information such as, for example, the customer's food preferences, food allergies, and information about how often the customer has frequented the establishment (and possibly what the customer typically spends there). This information allows the staff to greet the guest by name, make intelligent menu suggestions, and make special offers to the customer as may be appropriate (e.g., in the event that the customer typically spends above a certain dollar threshold).

It will be appreciated that the systems and methodologies disclosed herein have a wide range of applications, both within and outside of the hospitality industry. For example, the overlay may be utilized to track people on a waiting list at restaurants, night clubs, movie theatres, concerts, theme parks, and various other venues or establishments.

As a further example, the overlay could be used to provide a user's page on a social media site such as the FACEBOOK® social media site, so that the user can see how the page appears on the Internet or other network as changes are made to it.

The systems and methodologies disclosed herein also have many applications in the retail industry. For example, the overlay may be utilized to implement some or all of the method for making secure payments in face to face transactions which is disclosed in U.S. 2013/0254107 (McClure et al.). In particular, the overlay may be utilized to display the offers 405 received at the POS terminal as seen in FIGS. 12-27 thereof.

In some embodiments, the systems, methodologies and software disclosed herein may be implemented on one or more computational devices. Such computational devices may include one or more hardware central processing units (CPU) that carry out the functions of the device, and may also comprise an operating system configured to perform executable instructions. Such computational devices may also have the ability to connect to, access or interface with a network, a cloud computing infrastructure, an intranet, and/or one or more data storage devices. Preferably, these computational devices are connected to the Internet such that they access the World Wide Web.

Suitable computational devices that may be utilized to implement portions of the systems, methodologies and software disclosed herein include, but are not limited to, POS terminals, server computers, desktop computers, laptop computers, notebook computers, sub-notebook computers, netbook computers, netpad computers, set-top computers, handheld computers, Internet appliances, mobile smartphones, tablet computers (including those with booklet, slate, and convertible configurations), personal digital assistants, video game consoles, and vehicles. Any of the foregoing devices may have one or more storage and/or memory devices associated with it which may be any suitable type as is known to the art.

In some embodiments, the foregoing computational devices may include an operating system which is configured to perform executable instructions. Such an operating system may comprise, for example, software (including programs and data) which manages the hardware associated with the computational device and which provides services for the execution of applications. Suitable server operating systems which may be utilized for this purpose may include, but are not limited to, FreeBSD, OpenBSD, NetBSD®, Linux, Apple® Mac OS X Server®, Oracle® Solaris®, Windows Server®, and Novell® NetWare®. Suitable personal computer operating systems which may be utilized for this purpose may include, but are not limited to, Microsoft® Windows®, Apple® Mac OS X®, UNIX®, and UNIX-like operating systems such as GNU/Linux®. Suitable operating systems for smart phones and other mobile communications devices which may be utilized for this purpose may include, but are not limited to, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS . In some embodiments of the systems and methodologies described herein, the operating system may be provided, in whole or in part, through cloud computing.

In some embodiments of the systems and methodologies described herein, the computational device may include a display to communicate information visually to a user. The display may be, for example, a cathode ray tube (CRT) display, a liquid crystal display (LCD), a thin film transistor liquid crystal display (TFT-LCD), an organic light emitting diode (OLED) display, a plasma display, a video display, a heads-up display, or the like.

In some embodiments of the systems and methodologies described herein, the computational device may include or be equipped with one or more input devices to receive information from a user. Such input devices may include, for example, various tactile devices, keyboards, pointing devices (such as, for example, mice, trackballs, track pads, joysticks, game controllers, or styluses), touch screens or multi-touch screens, microphones, video cameras, or various combinations or sub-combinations of the foregoing input devices.

In some embodiments of the systems and methodologies described herein, the computational device may include a non-transitory, computer readable, and preferably tangible storage medium or media which is encoded with a program or other operating instructions that are executable by the operating system of the computational device, by one or more processors associated with the computational device, or by another device that the computational device is in communication with. These instructions may include instructions for the purpose of implementing the systems and methods disclosed herein. In some embodiments, the computer readable storage medium may be removable from the computational device. The computer readable storage medium may include, but is not limited to, CD-ROMs, DVDs, flash memory devices, solid state memory, magnetic disk drives, magnetic tape drives, optical disk drives, cloud computing systems and services, and the like. The program or other operating instructions may be permanently, substantially permanently, semi-permanently, or non-transitorily encoded on the medium or media.

In some embodiments of the systems and methodologies described herein, the computational device may include one or more computer programs in the form of a sequence of instructions which are executable in the computational device's CPU, and which are written to perform a specified task. These computer readable instructions may be implemented as program modules, such as functions, objects, Application Programming Interfaces (APIs), data structures, and the like, that perform particular tasks or implement particular abstract data types, and may be written in various versions of various languages.

In the systems and methodologies described herein, the functionality of the computer program (or programs) or computer readable instructions may be combined or distributed as desired in various environments. For example, any computer program utilized in the systems and methodologies described herein may comprise one or more sequences of instructions which may be provided from one or more locations, and may include one or more software modules. In some embodiments, such a computer program may include, in part or in whole, one or more components selected from the group consisting of web applications, mobile applications, standalone applications, and web browser plug-ins, extensions, add-ins, and add-ons.

In some embodiments of the systems and methodologies described herein, such a computer program may include a web application which, in various embodiments, may utilize one or more software frameworks and one or more database systems. In some embodiments of the systems and methodologies disclosed herein, the web application may be created upon a software framework such as Microsoft®.NET or Ruby on Rails (RoR), and may utilize one or more database systems such as, for example, relational, non-relational, object oriented, associative, or XML database systems. Relational database systems that may be utilized may include, for example, Microsoft® SQL Server, mySQL™, and Oracle®. Moreover, the web application may be written in one or more versions of one or more languages such as, for example, markup languages, presentation definition languages, client-side scripting languages, server-side coding languages, database query languages, or various combinations or sub-combinations thereof

In some embodiments of the systems and methodologies described herein, the web application may be written at least partially in (a) a markup language such as Hypertext Markup Language (HTML), Extensible Hypertext Markup Language (XHTML), or eXtensible Markup Language (XML); a presentation definition language such as, for example, Cascading Style Sheets (CSS); a client-side scripting language such as, for example, Asynchronous Javascript and XML (AJAX), Flash® Actionscript, Javascript, or Silverlight®; a server-side coding language such as, for example, Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy; or a database query language such as, for example, Structured Query Language (SQL).

In some embodiments of the systems and methodologies described herein, the web application may integrate enterprise server products such as, for example, IBM® Lotus Domino®. The web application may also include a media player element which may utilize one or more suitable multimedia technologies such as, for example, Adobe® Flash®, HTML5, Apple® QuickTime®, Microsoft® Silverlight®, Java™, or Unity®.

In some embodiments of the systems and methodologies described herein, a computer program may be utilized which includes a mobile application which is provided to a mobile computational device or mobile technology platform. The mobile application may be provided to the mobile computational device at the time it is manufactured or at a later time by way of download over a suitable network. The mobile application may be created by techniques known to the art using hardware, languages, and development environments which are also known to the art, and may be written in several languages. Suitable programming languages include, for example, C, C++, C#, Objective-C, Java™, Javascript, Pascal, Object Pascal, Python™, Ruby, VB.NET, WML, and XHTML/HTML with or without CSS, and various combinations or sub-combinations thereof.

Several mobile application development environments are known to the art and may be utilized in the development of the mobile application. These include, without limitation, AirplaySDK, alcheMo, Appcelerator®, Celsius, Bedrock, Flash Lite, .NET Compact Framework, Rhomobile, WorkLight Mobile Platform, Lazarus, MobiFlex, MoSync, and Phonegap. Several mobile device manufacturers also currently distribute software developer kits including, for example, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for the distribution of mobile applications. These include, for example, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, the systems and methodologies described herein may utilize a computer program which includes one or more standalone applications. Such standalone applications may be programs that are run as an independent computer process (that is, not as an add-on to an existing process, e.g., not a plug-in). Such standalone applications are often compiled. A compiler is a computer program(s) that transforms source code written in a programming language into binary object code such as assembly language or machine code. Suitable compiled programming languages may include, by way of example, C, C++, Objective-C, COBOL, Delphi, Eiffel, Java™, Lisp, Python™, Visual Basic, and VB.NET. Compilation is often performed, at least in part, to create an executable program. In some embodiments of the systems and methodologies described herein, the computer program may include one or more executable complied applications.

In some embodiments, the systems and methodologies described herein may include software, server, and/or database modules, or use of the same. Such software modules may be created by techniques known to the art (possibly by using machines, software, and languages known to the art), and may be implemented in various ways. These software modules may comprise one or more files, section of codes, programming objects, programming structures, or various combinations or sub-combinations thereof. In some embodiments of the systems and methodologies described herein, the software modules may comprise a web application, a mobile application, and/or a standalone application. The software modules may be present in one or more computer programs or applications, and may be hosted on one or more machines or cloud computing platforms which may be in one or more locations.

In some embodiments, the systems and methodologies described herein may include one or more databases, or use of the same. Such databases may include, for example, relational databases, non-relational databases, object oriented databases, object databases, entity-relationship model databases, associative databases, and XML databases. These databases may be Internet-based, web-based, cloud computing-based, or may be based on one or more local computer storage devices.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It is specifically contemplated that the various elements set forth in the following claims may be presented in future claims in various combinations and sub-combinations, and hence doing so does not depart from the scope of the present invention.

1. A system, comprising:
a point of sale (POS) terminal equipped with a touch screen display and having a first instance of POS software thereon which renders a first window on the display which is populated with a plurality of interactable objects; and
a second instance of POS software installed on the POS terminal which generates a user selectable object on the display, wherein selection of the user selectable object generates an overlay in the form of a floating window that occupies a first region of the display and which floats over any objects rendered in the first region by the first POS software.

2. (canceled)

3. The system of claim 1, wherein the user selectable object is repositionable around the first window by the user or by the second instance of the POS software.

4. (canceled)

5. The system of claim 1, wherein the user selectable object is dynamically repositionable by the second instance of the POS software so that overlap between the user selectable object and the plurality of interactable objects rendered on the first window is avoided or minimized.

6. The system of claim 1, wherein the overlay includes a plurality of items, wherein each item includes (a) a descriptive area, and (b) an action area through which the information in the descriptive area may be acted upon.

7. The system of claim 1, wherein the action area includes a first selectable feature, the selection of which (a) opens on the POS system a new file selected from the group consisting of tickets and orders, and (b) links the file to the information in the descriptive area.

8. The system of claim 7, wherein the action area includes a second selectable feature, the selection of which (a) opens on the POS system an existing file selected from the group consisting of tickets and orders, and (b) links the file to the information in the descriptive area.

9. The system of claim 1, wherein the second instance of POS software detects instances of events in which a user interacts with the interactable objects in the first window when the overlay is present, and wherein the second instance of POS software prevents the overlay from losing focus when detected instances of events occur.

10. (canceled)

11. The system of claim 1, wherein the second instance of POS software allows interactions with any interactable objects in the first window that the overlay does not cover to pass through to the first instance of POS software, and wherein the second instance of POS software operates independently of the first instance of POS software.

12. (canceled)

13. The system of claim 1, wherein the POS system is in communication with a beacon that detects when a mobile communications device which has a mobile client installed thereon is within a predefined distance from the beacon, wherein the beacon is part of a geofence, and wherein the beacon is in communication with a server via a network. _cm 14-15. (canceled)

16. The system of claim 13, wherein the mobile communications device is also in communication with the server via the network.

17. The system of claim 1, wherein the server is in communication with a database.

18. The system of claim 1, wherein the mobile communications device interacts with the beacon, and communicates to the server the fact that the interaction occurred and wherein, in response to the interaction, the second instance of POS software is adapted to download information from the server and to present the information in the overlay.

19. (canceled)

20. The system of claim 1, wherein the beacon is associated with an establishment, wherein the mobile communications device is associated with a customer of the establishment, and wherein the information downloaded from the server and presented to the overlay is associated with the customer.

21. The system of claim 1, wherein the information downloaded from the server and presented to the overlay includes at least one item selected from the group consisting of a picture of the customer and the customer's name, a listing of food items that the customer is allergic to, a listing of food preferences the customer has, an offer of payment from the customer to the establishment.

22-24. (canceled)

25. The system of claim 21, wherein the information downloaded from the server and presented to the overlay includes an offer of payment from the customer to the establishment, and wherein the offer of payment includes a picture of the customer and the amount of the payment.

26. The system of claim 1, wherein the offer is received at the POS terminal as part of a face-to-face transaction between the customer and the establishment.

27. A tangible, non-transient, computer readable medium having suitable programming instructions recorded therein which, when executed by one or more computer processors, performs the method of claim 1.

28. In combination with a point of sale (POS) terminal equipped with a touch screen display, a tangible, non-transient, computer readable medium having suitable programming instructions recorded therein which, when executed by one or more computer processors, performs the method of:
rendering a first window on the display which is populated with a plurality of interactable objects; and
generating a user selectable object on the display, wherein selection of the user selectable object generates an overlay in the form of a floating window that occupies a first region of the display and which floats over any objects rendered in the first region.

29. The combination of claim 27, wherein the POS system is in communication with a beacon that detects when a mobile communications device which has a mobile client installed thereon is within a predefined distance from the beacon, wherein the beacon is in communication with a server via a network, wherein the mobile communications device is also in communication with the server via the network, and wherein the mobile communications device is adapted to interact with the beacon, and to communicate to the server the fact that the interaction occurred.

30. The combination method of claim 27, further comprising:
in response to the interaction, downloading information from the server; and
presenting present the downloaded information in the overlay.

31-38. (canceled)
